(19) United States
(12) Patent Application Publication
(10) Pub. No.: US 2019/0039871 A1
(43) Pub. Date: Feb. 7, 2019

(54) Can Opener

(71) Applicant: John Morris, Los Angeles, CA (US)

(72) Inventor: John Morris, Los Angeles, CA (US)

(21) Appl. No.: 15/903,896

(22) Filed: Feb. 23, 2018

Related U.S. Application Data
(60) Provisional application No. 62/540,238, filed on Aug. 2, 2017.

(51) Int. Cl. B67B 7/46

(52) U.S. Cl. CPC B67B 7/30; B67B 2007/303

(57) ABSTRACT

A can opener. The can opener includes a housing having a closed upper end and an open lower end, forming an interior volume therein. The interior volume is dimensioned to fit a can therein. A handle is affixed to an exterior surface of the housing. A knob is affixed to the closed upper end and is connected to a plurality of blades affixed to an interior surface of the housing. The plurality of blades can move between an extended position and a retracted position when the knob is actuated. A linear distance between a distal end of each of the plurality of blades and the interior surface is greater when the blades are in the extended position.

### CROSS REFERENCE TO RELATED APPLICATIONS

This application claims the benefit of U.S. Provisional Application No. 62/540,238 filed on Aug. 2, 2017. The above identified patent application is herein incorporated by reference in its entirety to provide continuity of disclosure.

### BACKGROUND OF THE INVENTION

The present invention relates to a can opener. Specifically, it relates to a can opener having a plurality of adjustable blades, such that the can opener can open cans having various diameters.

Many people use can openers to remove the lids from sealed cans, however traditional can openers can be difficult and frustrating to operate, especially for the elderly or those with dexterity issues, such as arthritis. Operating a traditional can opener often requires excessive forces to be applied to a frequently difficult to grip handle, which can be time consuming and frustrating for a user. Additionally, traditional can openers create a sharp metal edge on the cans after the cans are opened, which can lead to a user cutting themselves, potentially leading to serious injury. Therefore, a can opener that can easily remove a lid from a can while not creating dangerously sharp edges on the can is desired.

In light of the devices disclosed in the known art, it is submitted that the present invention substantially diverges in design elements from the known art and consequently it is clear that there is a need in the art for an improvement to existing can openers. In this regard, the instant invention substantially fulfills these needs.

### SUMMARY OF THE INVENTION

In view of the foregoing disadvantages inherent in the known types of can openers now present in the prior art, the present invention provides a can opener wherein the same can be utilized for providing convenience for the user when opening various diameters of cans without creating sharp edges thereon.

The present system comprises a housing having a closed upper end and an open lower end, the housing forming an interior volume therein, wherein the interior volume is configured to receive a can therein. A handle is affixed to an exterior surface of a sidewall of the housing. A knob is rotatably affixed to the closed upper end, wherein the knob is operably connected to a plurality of blades disposed within the interior volume. The plurality of blades are adjustably affixed to an interior surface of the sidewall and are configured to selectively move between an extended position and a retracted position when the knob is actuated. A linear distance between a distal end of each of the plurality of blades and the interior surface is greater when the plurality of blades are in the extended position. In some embodiments, the plurality of blades are disposed equiangularly about the interior surface of the sidewall. In another embodiment, the distal end of the plurality of blades comprises a semi-circular shape. In other embodiments, the plurality of blades taper to a sharpened edge along a perimeter thereof from an upper surface of each blade and a lower surface of each blade. In yet another embodiment, the sharpened edge comprises a convex grind along the lower surface. In some embodiments, the sharpened edge comprises a convex grind along the upper surface. In another embodiment, the handle comprises a cushioned surface thereon. In other embodiments, the knob tapers from a base thereof towards a top thereof. In yet another embodiment, the knob comprises a plurality of depressions, wherein the depression are configured to provide a gripping surface. In some embodiments, the knob comprises a material having a coefficient of friction greater than one. In another embodiment the handle comprises a material having a coefficient of friction greater than one.

A method of using a can opener comprises providing a cap opener comprising a housing having a closed upper end and an open lower end forming an interior volume therein, wherein the interior volume is configured to receive a can therein, inserting the can into the interior volume, actuating a knob rotatably affixed to the closed upper end to extend a plurality of blades from an interior surface of a sidewall of the housing, such that the plurality of blades pierce a wall of the can, gripping a handle affixed to an exterior surface of the sidewall, rotating the handle about a longitudinal axis of the can, and removing the can opener from the can.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the can opener.

FIG. 2 shows a lower view of an embodiment of the can opener.

FIG. 3 shows a perspective view of an embodiment of the blades of the can opener.

FIG. 4 shows an exploded view of an embodiment of the can opener in use.

### DETAILED DESCRIPTION OF THE INVENTION

Reference is made herein to the attached drawings. Like reference numerals are used throughout the drawings to depict like or similar elements of the can opener. For the purposes of the following description, the can opener is contemplated to comprise a plurality of blades disposed within the interior of the housing, however embodiments comprising a single blade are contemplated. The figures are intended for representative purposes only and should not be considered to be limiting in any respect.

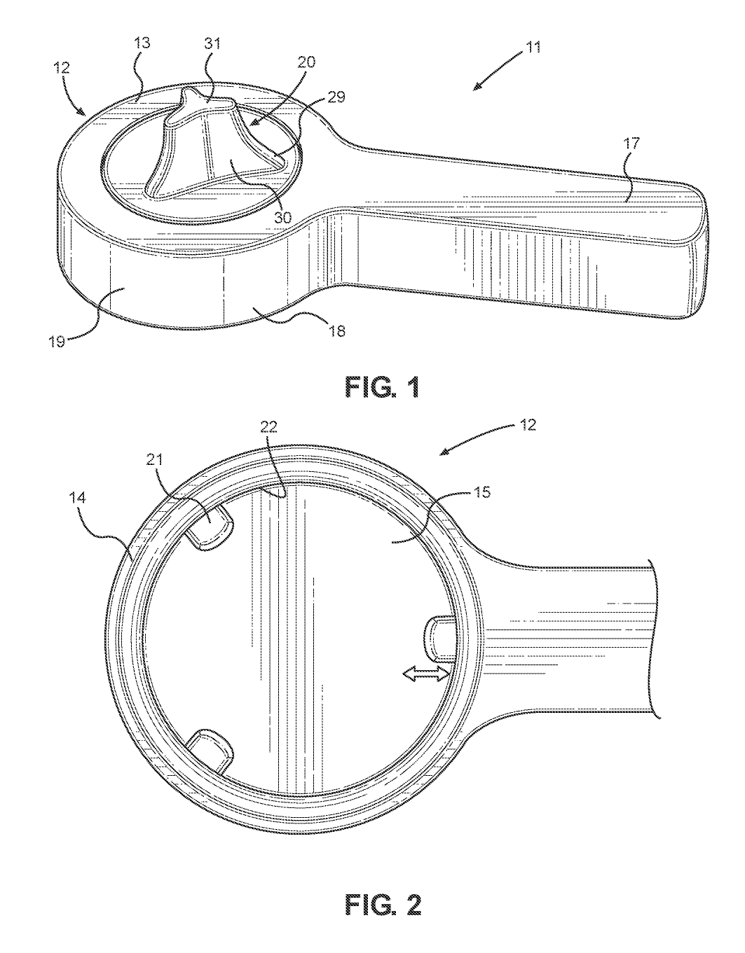

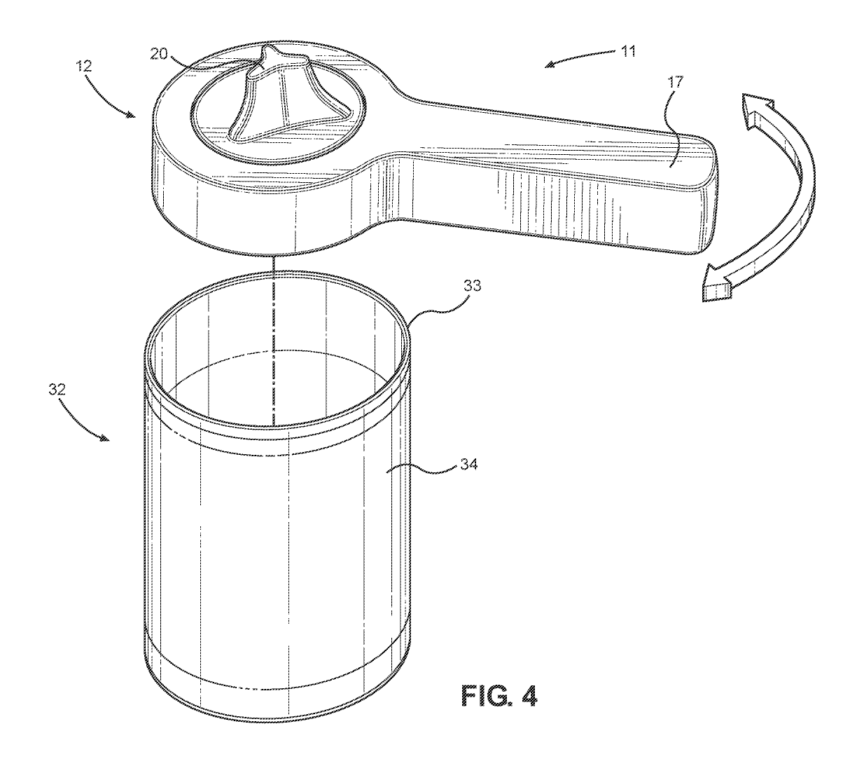

Referring now to FIGS. 1 and 2, there is shown a perspective view of an embodiment of the can opener and a lower view of an embodiment of the can opener, respectively. The can opener 11 comprises a housing 12 having a closed upper end 13, an open lower end 14, and a sidewall 19 extending therebetween. The closed upper end 13, the open lower end 14, and the sidewall 19 define an interior volume 15, wherein the interior volume 15 is configured to receive a can (shown in FIG. 4, 32) therein. In the illustrated embodiment, the housing 12 comprises a circular cross-section, allowing the can opener 11 to occupy less space, thereby increasing portability, however alternate cross-sections are contemplated.

The housing 12 further comprises a knob 20, wherein the knob 20 is rotatably disposed on the closed upper surface 13. In the illustrated embodiment, the knob 20 further comprises a plurality of depressions 30, wherein the plurality of depressions 30 are configured to provide a gripping surface for the user. In this way, the user can easily rotate the knob 20, as the plurality of depressions 30 allow a user to apply forces along a tangential axis while a finger of a user occupies each of the plurality of depressions, thereby allowing the user to maintain a strong grip on the knob 20 during use. In the illustrated embodiment, the knob 20 tapers from a base 29 of the knob 20 towards a top 31 of the knob 20. In this way, the knob 20 comprises a greater surface area towards the base 29, allowing a user to apply increased torque to the knob 20 at the base 29 in order to actuate the knob 20.

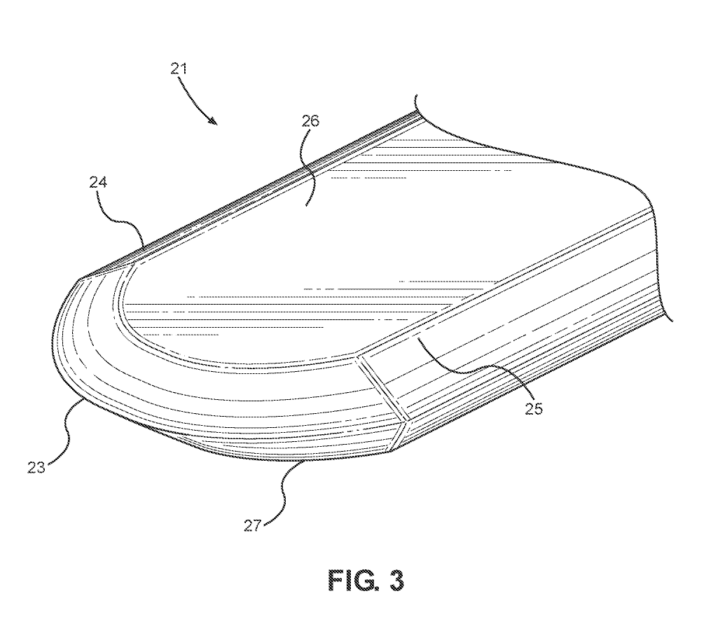

The can opener 11 further comprises a plurality of blades 21 disposed within the interior volume 15. The plurality of blades 21 are adjustably disposed within the sidewall 19 and extend from an interior surface 22 of the sidewall 19. The plurality of blades 21 are configured to selectively move between an extended position and a retracted position when the knob 20 is actuated. The rotation of the knob 20 is translated into linear movement of the plurality of blades 21, such that a linear distance between a distal end (shown in FIG. 3, 23) of the plurality of blades 21 and the interior surface 22 is greater when the plurality of blades 21 are in the extended position. In this way, the can opener 11 can be used to open cans having a variety of diameters. The plurality of blades 21 are configured to pierce and engage a wall (shown in FIG. 4, 34) of the can when in the extended position, such that the user can rotate the housing 12 when the blades 21 are extended to remove an upper portion of the can. In the illustrated embodiment, the plurality of blades 21 are disposed equiangularly about the interior surface 22. In this way, the user must rotate the housing 12 about a can across an arc length equal to the distance between adjacent blades 21 in order to cut through a full circumference of the can. Increasing the number of blades 21 therefore decreases the amount the user must rotate the housing 12 about a can to open the can.

The can opener 11 further comprises a handle 17 extending from an exterior surface 18 of the sidewall 19. In some embodiments, the handle 17 comprises a cushioned surface thereon, so as to provide the user with a comfortable gripping surface. In another embodiment, the handle 17 comprises an ergonomic grip, configured to conform to a hand of the user. In the illustrated embodiment, the handle 17 comprises a material having a coefficient of friction greater than one, such that the hand of the user is frictionally engaged therewith in use, thereby preventing slippage along the handle 17.

Referring now to FIG. 3, there is shown a perspective view of an embodiment of the blades of the can opener. In the illustrated embodiment, each blade 21 further comprises a sharpened edge 24 disposed along a perimeter 25 of the blade 21. In this way, the blade 21 is configured to cut into an object. In the illustrated embodiment, the sharpened edge 24 tapers from an upper surface 26 of the blade 21 and a lower surface 27 of the blade 21. In some embodiments, the sharpened edge 24 comprises a beveled grind, wherein the sharpened edge 24 tapers to a point, however, in the illustrated embodiment, the sharpened edge 24 comprises a convex grind, wherein the blade 21 gradually tapers to the sharpened edge 24 such that the taper produces a rounded cross section. In this way, the blade 21 is configured to simultaneously cut through a can, while rolling the wall of the can away from the direction of the cut. This prevents the edge of the can from forming a dangerously sharp edge that can cut the user. In the illustrated embodiment, the distal end 23 of the plurality of blades 21 comprises a semi-circular shape. In this way, the plurality of blades 21 comprise a cutting edge along the front and sides of the distal end 23, allowing the distal end 23 to cut into a can, as well as to cut as the blade 21 is moved in either direction as the housing is rotated.

Referring now to FIG. 4, there is shown an exploded view of an embodiment of the can opener in use. In an exemplary use, the user places the housing 12 of the can opener 11 over an upper end 33 of the can 32, such that the upper end 33 rests within the interior volume of the housing 12. The user then rotates the knob 20 to extend the plurality of blades such that the sharpened edge of the blades pierce through the wall 34 of the can 32. The user then grips the handle 17 and rotates the handle 17 about a longitudinal axis of the can 32, such that the plurality of blades cut through the wall 34, thereby removing the upper end 33 from the can 32. The user then removes the can opener 11 from the can 32. The edge of the can 32 along the cut is rounded, thereby preventing the user from being injured by the can 32.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A can opener, comprising:
a housing having a closed upper end, wherein a sidewall and an open lower end form an interior volume therein;
wherein the interior volume is configured to receive an end of a can therein;
a knob rotatably affixed to the closed upper end;
a blade adjustably affixed to an interior surface of the sidewall;
wherein the knob is operably connected to the plurality of blades;
wherein the blade is configured to selectively move between an extended position and a retracted position when the knob is actuated;
wherein a linear distance between a distal end of the blade and the interior surface is greater when in the extended position.

2) The can opener of claim 1, wherein the blade comprises a plurality of blades disposed equiangularly about the interior surface of the sidewall.

3) The can opener of claim 1, wherein the distal end of the blade comprises a semi-circular shape.

4) The can opener of claim 1, wherein the blade tapers to a sharpened edge along a perimeter thereof from an upper surface of the blade and a lower surface of the blade.

5) The can opener of claim 4, wherein the sharpened edge comprises a convex grind along the lower surface.

6) The can opener of claim 4, wherein the sharpened edge comprises a convex grind along the upper surface.

7) The can opener of claim 1, further comprising a handle affixed to an exterior surface of the sidewall.

8) The can opener of claim 7, wherein the handle comprises a cushioned surface thereon.

9) The can opener of claim 1, wherein the knob tapers from a base thereof towards a top thereof.

10) The can opener of claim 9, wherein the knob further comprises a plurality of depressions, wherein the depressions are configured to provide a gripping surface.

11) The can opener of claim 1, wherein the knob is disposed flush with the upper surface of the closed upper end.

12) The can opener of claim 1, wherein the closed upper end includes a border encompassing the entirety of the knob.

13) A method of using a can opener, comprising:
receiving a can into an interior volume of a housing of the can opener formed by an open lower end and a sidewall;
actuating a knob rotatably affixed to a closed upper end of the housing to extend a blade from an interior surface of the sidewall, such that the blade pierces the can;
gripping a handle affixed to the housing;
rotating the handle about a longitudinal axis of the can.

14) The method of using the can opener of claim 13, further comprising separating the can opener from the can.
